(19) United States
(12) Patent Application Publication
(10) Pub. No.: US 2026/0072375 A1
(43) Pub. Date: Mar. 12, 2026

(54) DEVELOPER CARRYING MEMBER AND MANUFACTURING METHOD THEREOF

(71) Applicant: KYOCERA Document Solutions Inc., Osaka (JP)

(72) Inventors: Makoto SHISHIDO, Osaka (JP); Yukimasa WATANABE, Osaka (JP)

(73) Assignee: KYOCERA Document Solutions Inc., Osaka (JP)

(21) Appl. No.: 19/318,673

(22) Filed: Sep. 4, 2025

(30) Foreign Application Priority Data
Sep. 11, 2024 (JP) 2024-157159

(51) Int. Cl. G03G 15/08; G03G 15/09

(52) U.S. Cl. CPC G03G 15/0818; G03G 15/0928; G03G 2215/0861; G03G 2215/0863

(57) ABSTRACT

A developer carrying member includes a shaft, a magnet, a sleeve, a flange, and adhesive. The flange has a first fitting portion, a second fitting portion, and a groove portion. The adhesive is disposed in the groove portion. A first groove portion and a second groove portion are formed continuously in this order from the first fitting portion side to the second fitting portion side. The height from the bottom surface of the second groove portion to the outer circumferential surface of the first fitting portion is greater than that from the bottom surface of the first groove portion to the outer circumferential surface of the first fitting portion.

### INCORPORATION BY REFERENCE

This application is based on and claims the benefit of priority from Japanese Patent Application No. 2024-157159 filed on September 11, 2024 the contents of which are hereby incorporated by reference.

### BACKGROUND

The present disclosure relates to a developer carrying member and a method for manufacturing the same.

An electrophotographic image forming apparatus includes a developing device. The developing device is provided with a developer carrying member. The developer carrying member rotates while carrying developer and supplies the developer to an image carrying member.

The developer carrying member has a cylindrical sleeve, a magnet disposed inside the sleeve, and a flange fixed to an end opening of the sleeve. The developer is carried on the outer circumferential surface of the sleeve.

### SUMMARY

According to a first aspect of the present disclosure, a developer carrying member includes a shaft, a magnet, a sleeve, a flange, and adhesive. The shaft extends in a predetermined direction. The magnet is fixed to an outer circumferential surface of the shaft. The sleeve is in a cylindrical shape with the shaft as its central axis, and carries developer on its outer circumferential surface. The flange is fixed to an end opening of the sleeve in the predetermined direction, and is rotatably supported on the shaft to rotate together with the sleeve about the central axis. The adhesive bonds together the sleeve and the flange. The flange has a fitting portion in a cylindrical shape that is fitted inside the sleeve through the end opening. The fitting portion has a first fitting portion, a second fitting portion, and a groove portion. The first fitting portion contacts the inner circumferential surface of the sleeve. The second fitting portion has the same outer diameter as the first fitting portion and contacts the inner circumferential surface of the sleeve at a position closer to the end opening than the first fitting portion. The groove portion is formed between the first and second fitting portions in the predetermined direction and is recessed in a radial direction with respect to the outer circumferential surfaces of the first and second fitting portions. The adhesive is disposed in the groove portion. The groove portion has a first groove portion and a second groove portion. The first and second groove portions are formed continuously in this order in the predetermined direction from the first fitting portion side to the second fitting portion side. The height from the bottom surface of the second groove portion to the outer circumferential surface of the first fitting portion is greater than the height from the bottom surface of the first groove portion to the outer circumferential surface of the first fitting portion.

According to a second aspect of the present disclosure, a method of manufacturing a developer carrying member is a method of manufacturing the developer carrying member described above, and includes a process of applying adhesive to the first groove portion and a process of, with the adhesive applied to the first groove portion, press-fitting the fitting portion inside the sleeve through the end opening.

### BRIEF DESCRIPTION OF THE DRAWINGS

FIG. 1 is a schematic diagram of an image forming apparatus according to an embodiment.

FIG. 2 is a schematic diagram of and around a developing device according to the embodiment.

FIG. 3 is a schematic diagram of the developing device according to the embodiment.

FIG. 4 is a plan view of a developing roller according to the embodiment.

FIG. 5 is a sectional view along line A-A in FIG. 4.

FIG. 6 is an enlarged view of the part indicated by arrow B in FIG. 5.

FIG. 7 is a view of a flange alone according to the embodiment.

FIG. 8 is an enlarged view of and around a groove portion of the flange according to the embodiment.

FIG. 9 shows the results of experiment 1 conducted to test the effect of the embodiment.

FIG. 10 shows the results of experiment 2 conducted to test the effect of the embodiment.

FIG. 11 shows the results of experiment 3 conducted to test the effect of the embodiment.

FIG. 12 shows the results of experiment 4 conducted to test the effect of the embodiment.

FIG. 13 shows the results of experiment 5 conducted to test the effect of the embodiment.

FIG. 14 shows the results of experiment 6 conducted to test the effect of the embodiment.

### DETAILED DESCRIPTION

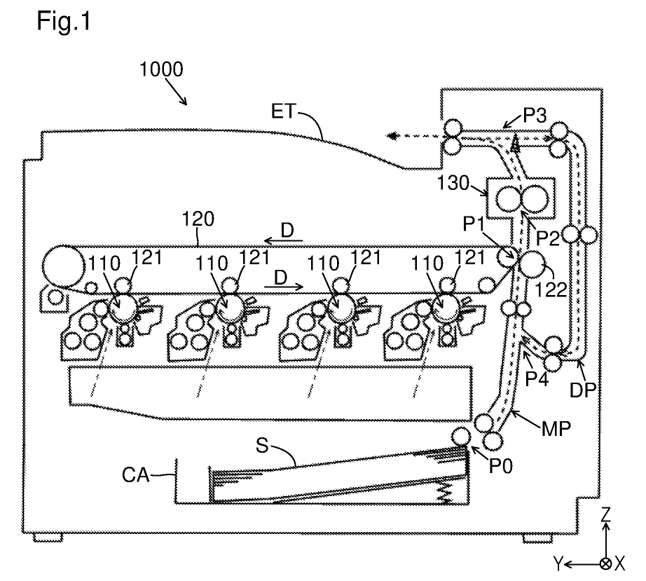

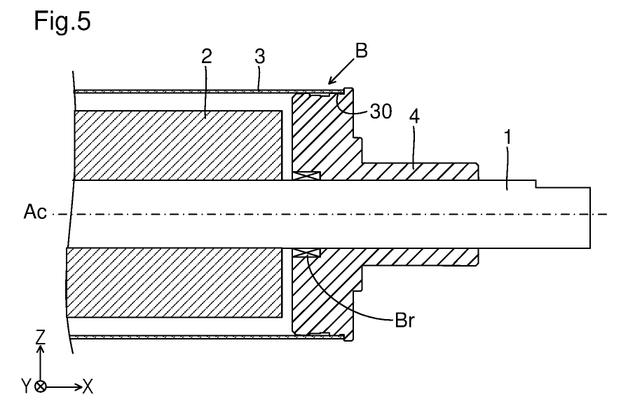

With reference to FIGS. 1 to 8, a developing roller 10 (corresponding to a “developer carrying member”) according to an embodiment will be described. The developing roller 10 is placed in an image forming apparatus 1000. Specifically, the developing roller 10 is placed in a developing device 100, and the developing device 100 is placed in the image forming apparatus 1000.

The image forming apparatus 1000 is a tandem-type color laser printer. However, this is not meant as any limitation. The image forming apparatus 1000 can be a monochrome printer, multifunction peripheral, facsimile machine, or the like.

The following description uses an XYZ orthogonal coordinate system for ease of understanding. Z direction is the vertical direction, and is the up-down direction of the image forming apparatus 1000. A flat surface on which the image forming apparatus 1000 is installed is a plane perpendicular to Z direction. The arrow direction of Z axis is the upward direction, and the opposite direction is the downward direction.

X direction is one horizontal direction and Y direction is another horizontal direction. For example, X direction corresponds to the front-back direction of the image forming apparatus 1000; Y direction corresponds to the left-right direction of the image forming apparatus 1000.

### Overall configuration of an image forming apparatus

As shown in FIG. 1, the image forming apparatus 1000 includes a main conveyance passage MP. The image forming apparatus 1000 also includes a sheet cassette CA. The sheet cassette CA is removably mounted in the main body of the image forming apparatus 1000. The sheet cassette CA stores sheets S to be used in a print job. The sheets S are fed from the sheet cassette CA to the main conveyance passage MP. The main conveyance passage MP leads from a feed position P0 for the sheets S via a transfer position P1 and a fixing position P2 in this order to reach a discharge tray ET.

In a print job, a sheet S in the sheet cassette CA is fed to the main conveyance passage MP at the feed position P0. The fed sheet S is then conveyed along the main conveyance passage MP. The image forming apparatus 1000 prints an image on the sheet S being conveyed. In other words, the image forming apparatus 1000 transfers a toner image to the sheet S being conveyed. At the transfer position P1, a transferring process to transfer the toner image to the sheet S being transported is performed. At the fixing position P2, a fixing process to fix the toner image to the sheet S is performed.

The image forming apparatus 1000 includes image forming portions 110 for the four colors of cyan, magenta, yellow, and black. The image forming portions 110 each form a toner image using toner of the corresponding color. Now, with focus on one image forming portion 110, its configuration will be described. The images forming portions 110 all have the same configuration; accordingly, for the configuration of the other image forming portions 110, the following description is to be referred to and no overlapping description will be repeated

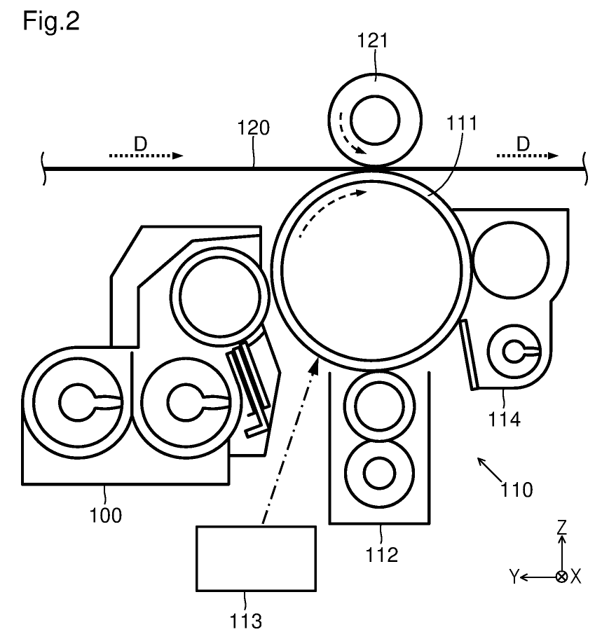

As shown in FIG. 2, the image forming portion 110 includes a developing device 100. The image forming portion 110 includes, in addition to the developing device 100, a photosensitive drum 111, a charging device 112, an exposure device 113, and a cleaning device 114.

During image formation by the image forming portion 110, the photosensitive drum 111 rotates. The charging device 112 electrostatically charges the outer circumferential surface of the photosensitive drum 111. The exposure device 113 exposes the outer circumferential surface of the photosensitive drum 111 to light to form an electrostatic latent image on the outer circumferential surface of the photosensitive drum 111. The developing device 100 feeds toner to the outer circumferential surface of the photosensitive drum 111 to develop the electrostatic latent image into a toner image. The cleaning device 114 removes the toner remaining on the outer circumferential surface of the photosensitive drum 111.

As shown in FIG. 1, the image forming apparatus 1000 includes an intermediate transfer belt 120. The intermediate transfer belt 120 is an endless belt. The intermediate transfer belt 120 contacts the outer circumferential surface of the photosensitive drum 111 and, in that state, rotates (turns around) in the direction indicated by arrow D.

The image forming apparatus 1000 includes a plurality of primary transfer rollers 121. The primary transfer rollers 121 are assigned one to each of the colors of cyan, magenta, yellow, and black. The primary transfer rollers 121 are disposed on the inner circumference side of the intermediate transfer belt 120. The primary transfer rollers 121 are disposed to face, across the intermediate transfer belt 120, the photosensitive drums 111 that carry toner images of the corresponding colors.

The image forming apparatus 1000 includes one secondary transfer roller 122. The secondary transfer roller 122 is kept in pressed contact with the outer circumferential surface of the intermediate transfer belt 120 at the transfer position P1. The secondary transfer roller 122 forms a transfer nip with the intermediate transfer belt 120. The main conveyance passage MP passes through the transfer nip.

In a print job, a sheet S is conveyed toward the transfer position P1 (i.e., the transfer nip). The sheet S conveyed passes through the transfer nip.

To the intermediate transfer belt 120, the toner image is primarily transferred from each photosensitive drum 111. The intermediate transfer belt 120 rotates while carrying the toner image on its outer circumferential surface. While the sheet S is passing through the transfer nip, the sheet S contacts the outer circumferential surface of the intermediate transfer belt 120. Thus, the toner image is secondarily transferred to the sheet S passing through the transfer nip.

Various rotating members, such as the photosensitive drum 111 in each image forming portion 110, rotate about an axis extending in X direction; likewise, the primary and secondary transfer rollers 121 and 122 and the like rotate about an axis extending in X direction.

The image forming apparatus 1000 includes a fixing portion 130. The fixing portion 130 includes a heating roller and a pressing roller. The fixing portion 130 is disposed at the fixing position P2. The heating roller incorporates a heater. The pressing roller is kept in pressed contact with the heating roller. The heating roller and the pressing roller are kept in pressed contact with each other to form a fixing nip at the fixing position P2.

In a print job, a sheet S that has undergone the toner image transferring process passes across the fixing position P2. Thus, the sheet S is nipped in the fixing nip between the heating roller and the pressing roller. The fixing portion 130 heats the sheet S passing across the fixing position P2. At the fixing position P2, a pressure is applied to the sheet S. The fixing portion 130 heats and presses the sheet S that has undergone the toner image transferring process to fix the toner image to the sheet S. After the fixing process, the sheet S is discharged to the discharge tray ET.

The image forming apparatus 100 includes a conveyance portion, though no reference sign is assigned to it. The conveyance portion includes a pair of conveyance rollers. The number of conveyor roller pairs provided is not particularly limited.

The pair of conveyance rollers includes a pair of rollers. The pair of rollers has a conveyance nip between the rollers. The pair of conveyance rollers rotates to convey the sheet S that has entered the conveyance nip. The conveyance portion conveys the sheet S along the main conveyance passage MP. The conveyance portion conveys a sheet S also along a duplex printing conveyance passage DP, which will be described later.

The image forming apparatus 1000 can perform, as a print job, not only a simplex printing job to print an image on only one side of a sheet S but also a duplex printing job to print images on both sides of a sheet S. For the duplex printing job, the image forming apparatus 1000 includes a duplex printing conveyance passage DP.

The duplex printing conveyance passage DP branches off the main conveyance passage MP at a branch position P3 downstream, in the sheet conveyance direction, of the fixing position P2 along the main conveyance passage MP. The duplex printing conveyance passage DP joins the main conveyance passage MP at a junction position P4 upstream, in the sheet conveyance direction, of the transfer position P1 along the main conveyance passage MP.

When the job being performed is a simplex printing job, the sheet S passes through the transfer nip only once, and the transferring process is performed once on the sheet S passing through the transfer nip. After the first-time transferring process, the sheet S is discharged as it is to the discharged tray ET.

When the job being performed is a duplex printing job, the sheet S passes through the transfer nip twice so that the transferring process is performed once for each of the front and back sides of the sheet S. Specifically, when the sheet S passes through the transfer nip first time, the transferring process is performed on one side of the sheet S. When after the first-time transferring process the trailing end of the sheet S passes across the branch position S3, before the sheet S is completely discharged to the discharge tray ET, the sheet S is switched back. Thus, the sheet S is pulled into the duplex printing conveyance passage DP from its trailing end.

The sheet S is then conveyed along the duplex printing conveyance passage DP. Then, the sheet S in the duplex printing conveyance passage DP is returned to the main conveyance passage MP at the junction position P4. The sheet S returned to the main conveyance passage MP is conveyed along the main conveyance passage MP and passes through the transfer nip again. Here, the front and back sides of the sheet S are reversed compared with when it passed there the previous time. Thus, when the sheet S passes through the transfer nip second time, the transferring process is performed on the other side of the sheet S, which is opposite to one side of the sheet S.

### Configuration of the Developing Device

Now, with focus on one developing device 100, its configuration will be described. The developing devices 100 all have basically the same configuration; accordingly, for the configuration of the other developing devices 100, the following description is to be referred to and no overlapping description will be repeated.

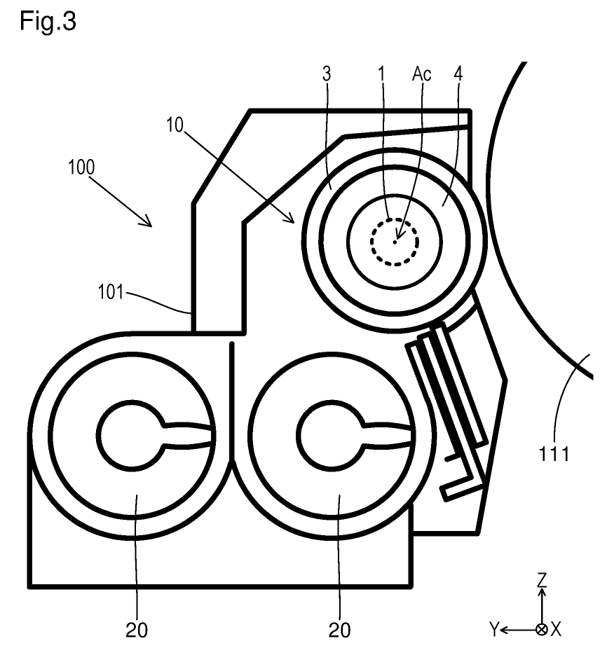

As shown in FIG. 3, the developing device 100 includes a developer container 101. The developer container 101 stores developer containing toner. The developer is, for example, magnetic one-component developer containing magnetic toner. The developing device 100 feeds the toner stored in the developer container 101 to the outer circumferential surface of the photosensitive drum 111 (i.e., to the electrostatic latent image).

The developing device 100 includes a developing roller 10. The developer roller 10 corresponds to a “developer carrying member.” The developer roller 10 is disposed inside the developer container 101. The developer roller 10 is supported so as to be rotatable about an axis extending in X direction. Of the developer roller 10, only an outer circumferential part including its outer circumferential surface is rotatable about an axis extending in the X direction.

The developing roller 10 has part of its outer circumferential surface exposed to outside the developer container 101. Specifically, the developer container 101 has an opening (no reference sign assigned) at a position opposite the photosensitive drum 111. Through this opening in the developer container 101, part of the outer circumferential surface of the developing roller 10 is exposed. Thus, the outer circumferential surface of the developing roller 10 faces the outer circumferential surface of the photosensitive drum 111. The developing roller 10 carries toner on its outer circumferential surface and feeds the toner to the electrostatic latent image on the outer circumferential surface of the photosensitive drum 111.

The developing device 100 includes two stirring screws 20. The stirring screws 20 are disposed inside the developer container 101. The stirring screws 20 are supported so as to be rotatable about an axis extending in X direction. The stirring screws 20 have a structure in which a blade is spirally wound around its rotating shaft. The stirring screws 20, by rotating, stir the developer.

### Configuration of the Developing Roller

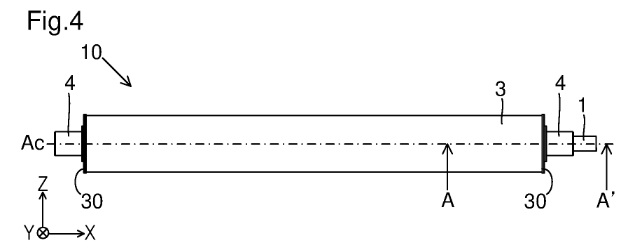

Referring to FIGS. 4 to 6, the configuration of the developing roller 10 will be described in detail below. In the following description, the direction in which the central axis Ac (rotation axis) of the developing roller 10 extends, that is, the X direction, is referred to as the axial direction, and the direction perpendicular to the central axis Ac is referred to as the radial direction. Along the axial direction, the direction toward the center of the developing roller 10 is referred to as axially inward, and the direction away from the center of the developing roller 10 is referred to as axially outward. Along the radial direction, the direction toward the center axis Ac is referred to as radially inward, and the direction away from the center axis Ac is referred to as radially outward.

The developing roller 10 has a shaft 1. The shaft 1 is a round bar and extends in the axial direction. That is, the axial direction corresponds to a “predetermined direction.” The central axis of the shaft 1 is the central axis Ac of the developing roller 10. The shaft 1 has a D-cut surface in one end part of it in the axial direction and is fixed so as not to be rotatable.

The developing roller 10 includes a magnet 2. The magnet 2 is fixed to the outer circumferential surface of the shaft 1. The magnet 2 extends in the axial direction. The magnet 2 has a plurality of magnetic poles in the circumferential direction of shaft 1.

The developer roller 10 includes a sleeve 3. The sleeve 3 is made of aluminum. The sleeve 3 is in a cylindrical shape about the shaft 1 as its central axis. The central axis Ac of the developing roller 10 coincides with the central axis of the sleeve 3. The shaft 1 is inserted inside the sleeve 3. That is, the magnet 2 is disposed inside the sleeve 3. In this state, the inner circumferential surface of the sleeve 3 and the magnet 2 face each other across an interval in the radial direction. The outer circumferential surface of the sleeve 3 is the outer circumferential surface of the developing roller 10.

The sleeve 3 carries developer (toner) on its outer circumferential surface. Under the magnetic force of the magnet 2, the developer is carried on the outer circumferential surface of the sleeve 3, and a magnetic brush is formed on the outer circumferential surface of the sleeve 3. The sleeve 3 rotates while carrying the developer on its outer circumferential surface and supplies the developer to the photosensitive drum 111.

The developing roller 10 has a flange 4. The flange 4 is made of aluminum. The flange 4 is fixed to an end opening 30 of the sleeve 3 in the axial direction.

The flange 4 has a bearing Br. The inner ring of bearing Br is fixed to the shaft 1 and the outer ring of bearing Br is fixed to the flange 4. Thus, the flange 4 is rotatably supported on the shaft 1. The flange 4 rotates together with the sleeve 3 about the central axis Ac (i.e., about the central axis of the shaft 1).

The flange 4 is fixed one to each of one end opening 30 of the sleeve 3 at one side in the axial direction and another end opening 30 of the sleeve 3 at the other side in the axial direction. That is, two flanges 4 are provided.

One flange 4 is penetrated by the shaft 1 in the axial direction. Thus, an end part of the shaft 1 with the D-cut surface protrudes outside the sleeve 3. The end portion of the shaft 1 that protrudes outside the sleeve 3 is clamped to prevent the shaft 1 from rotating. The other flange 4 is coupled to a motor (not shown). The other flange 4 is fed with a driving force from the motor to rotate about the central axis Ac (i.e., about the central axis of the shaft 1).

The two flanges 4 have the same structure except that one has a portion coupled to the motor. Accordingly, for convenience’ sake the two flanges 4 are identified by the same reference sign.

The developing roller 10 includes adhesive 5. The adhesive 5 bonds together the sleeve 3 and the flange 4. The type of adhesive 5 is not particularly limited. For example, the adhesive 5 is anaerobic. The adhesive 5 need not be anaerobic.

### Configuration of the Flange

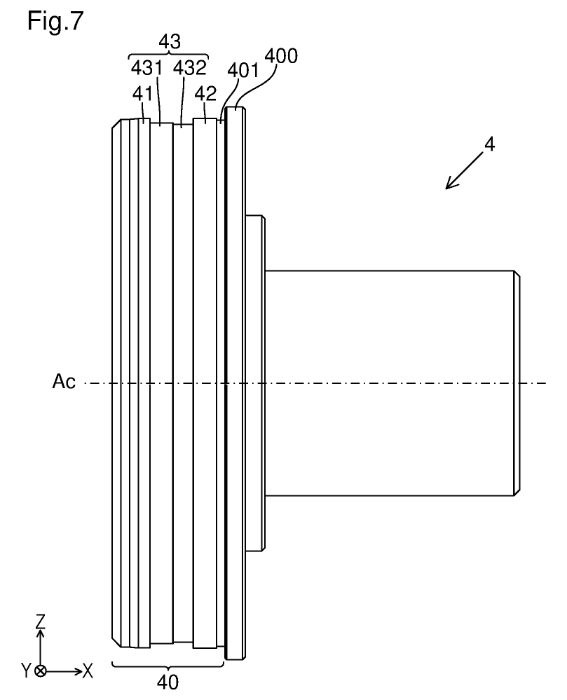

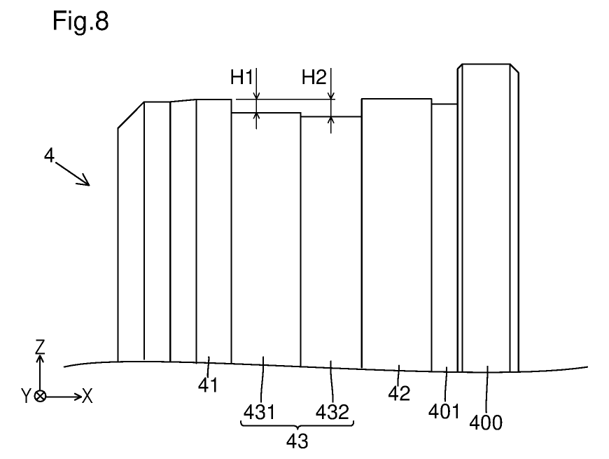

Now, referring to FIGS. 7 and 8, with focus on one flange 4, its structure will be described. The two flanges 4 have the same structure except that one has a portion coupled to the motor; accordingly, for the structure of the other flange 4, the following description is to be referred to and no overlapping description will be repeated.

The flange 4 has a fitting portion 40. The fitting portion 40 is in a cylindrical shape. The fitting portion 40 is a part disposed inside the sleeve 3. The fitting portion 40 is fitted inside the sleeve 3 through the end opening 30 of the sleeve 3. The fitting portion 40 is inserted inside the sleeve 3 from outside it in the axial direction. Fitting the fitting portion 40 inside the sleeve 3 permits the flange 4 to be secured in the end opening 30 of the sleeves 3.

The flange 4 has a brim portion 400. The brim portion 400 is a part located outward the fitting portion 40 in the axial direction. The brim portion 400 protrudes radially outward from the fitting portion 40 over the entire circumference of the flange 4.

The outer diameter of the brim portion 400 as viewed from the axial direction is greater than the maximum outer diameter of the fitting portion 40 as viewed from the axial direction. Therefore, the fitting portion 40 is inserted inside the sleeve 3 until the surface of the brim portion 400 facing axially inward (hereinafter referred to as the axially inward surface) contacts the surface of the sleeve 3 facing axially outward (hereinafter referred to as the axial end surface). Thus, the axial end surface of the sleeve 3 makes contact with the radially inward surface of the brim portion 400. This prevents displacement of the sleeve 3 in the axial direction.

The fitting portion 40 has a first fitting portion 41. The first fitting portion 41 makes contact with the inner circumferential surface of the sleeve 3. The fitting portion 40 also has a second fitting portion 42. The second fitting portion 42 is a part of the fitting portion 40 that is located axially outward of the first fitting portion 41. The second fitting portion 42 has the same outer diameter as the first fitting portion 41. Thus, the second fitting portion 42, together with the first fitting portion 41, contacts the inner circumferential surface of the sleeve 3, at the side closer to the end opening 30 of the sleeve 3 than the first fitting portion 41.

The first and second fitting portions 41 and 42 are parts of the fitting portion 40 with the largest outer diameters as viewed from the axial direction. The outer diameters of the first and second fitting portions 41 and 42 are larger than the inner diameter of the sleeve 3. Thus, the fitting portion 40 is press-fitted inside the sleeve 3.

The fitting portion 40 has a clearance groove portion 401. The clearance groove portion 401 is formed between the second fitting portion 42 and the brim portion 400 in the axial direction. The clearance groove portion 401 is a part recessed radially inward with respect to the outer circumferential surfaces of the first and second fitting portions 41 and 42. Thus, the clearance groove portion 401 is a part that has a smaller outer diameter than the first fitting portion 41 and the second outer circumferential surface. The clearance groove portion 401 extends continuously in the circumferential direction of the fitting portion 40 without a break.

Providing the clearance groove portion 401 in the fitting portion 40 allows the fitting portion 40 to be inserted inside the sleeve 3 until the axial end surface of the sleeve 3 makes contact with the axially inward surface of the brim portion 400. This allows close contact between the axial end surface of the sleeve 3 and the axially inward surface of the brim portion 400.

The fitting portion 40 further has a groove portion 43. The groove portion 43 is formed between the first and second fitting portions 41 and 42 in the axial direction. The groove portion 43 is a part recessed radially inward with respect to the outer circumferential surfaces of the first and second fitting portions 41 and 42. Thus, the groove portion 43 is a part that has a smaller outer diameter than the first fitting portion 41 and the second outer circumferential surface. The groove portion 43 is contiguous with the first fitting portion 41 at its axially inward side and is contiguous with the second fitting portion 42 at its axially outward side. The groove portion 43 extends continuously in the circumferential direction of the fitting portion 40 without a break.

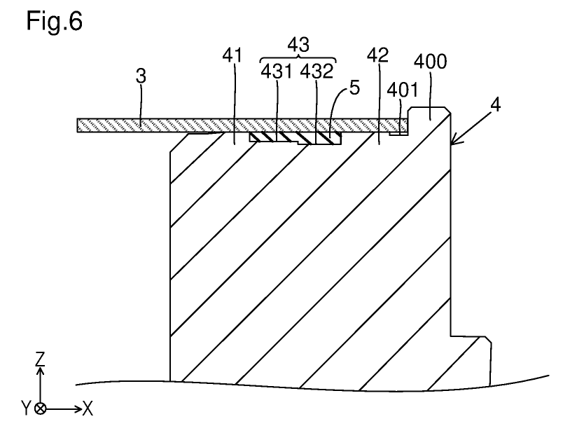

The adhesive 5 is disposed in the groove portion 43 (see FIG. 6). Thus, the adhesive 5 is disposed between the sleeve 3 and the flange 4 in the radial direction. The adhesive 5 fixes the flange 4 to the sleeve 3 by curing between the sleeve 3 and the flange 4 in the radial direction.

The groove portion 43 has a first groove portion 431 and a second groove portion 432. The first and second groove portions 431 and 432 are formed continuously in this order in the axial direction from the first fitting portion 41 side (i.e., axially inward) to the second fitting portion 42 side (i.e., axially outward). Thus, the first groove portion 431 is, at its axially inward side, contiguous with the first fitting portion 41 in the axial direction. The second groove portion 432 is, at its axially outward side, contiguous with the second fitting portion 42 in the axial direction. The first and second groove portions 431 and 432 are contiguous with each other in the axial direction.

Here, in this embodiment, the radial height H2 from the bottom surface of the second groove portion 432 to the outer circumferential surface of the first fitting portion 41 is greater than the radial height H1 from the bottom surface of the first groove portion 431 to the outer circumferential surface of the first fitting portion 41. Thus, the depth in the radial direction from the outer circumferential surface of the first fitting portion 41 to the bottom surface of the second groove portion 432 is greater than the depth in the radial direction from the outer circumferential surface of the first fitting portion 41 to the bottom surface of the first groove portion 431.

The radial height H1 from the bottom surface of the first groove portion 431 to the outer circumferential surface of the first fitting portion 41 is 0.10 mm or more but 0.50 mm or less. The radial height H2 from the bottom surface of the second groove portion 432 to the outer circumferential surface of the first fitting portion 41 is 0.20 mm or more but 0.55 mm or less. Here, the height H2 is greater than the height H1 by a margin of 0.20 mm or more but 0.55 mm or less. For example, if the height H1 is 0.10 mm, then the height H2 is 0.2 mm or more but 0.55 mm or less; if the height H1 is 0.50 mm, then the height H2 is 0.55 mm.

The optimum value of the radial height H2 from the bottom surface of the second groove portion 432 to the outer circumferential surface of the first fitting portion 41 varies depending on the type of adhesive 5. For example, when anaerobic adhesive is used as the adhesive 5, the radial height H2 from the bottom surface of the second groove portion 432 to the outer circumferential surface of the first fitting portion 41 is set to 0.20 mm or more but 0.50 mm or less.

In this embodiment, the first and second groove portions 431 and 432 together form the groove portion 43, in which the adhesive 5 is disposed. This prevents the adhesive 5 from spreading onto the outer circumferential surface of the sleeve 3 during the manufacturing of the developing roller 10. This will be described specifically below.

The manufacturing process of the developing roller 10 includes at least an adhesive application process and a flange press-fitting process. After the adhesive application process is performed, the flange press-fitting process is performed.

In the adhesive application process, the adhesive 5 is applied only to the first groove portion 431. The amount of adhesive applied to the first groove section 431 is set to an amount by volume that is 40% or more but 100% or less of the volume of the space defined by the inner surface of the first groove portion 431 and the inner circumferential surface of the sleeve 3.

In the flange press-fitting process, the fitting portion 40 is press-fitted inside the sleeve 3 with the adhesive 5 applied to the first groove portion 431. At this time, part of the adhesive 5 flows axially outward from the first groove portion 431. However, axially outward of the first groove portion 431 is disposed the second groove portion 432, which is deeper in the radial direction than the first groove portion 431. Thus, even if part of the adhesive 5 flows axially outward from the first groove section 431, the adhesive 5 collects in the second groove section 432. This makes it difficult for the adhesive 5 to spread onto the outer circumferential surface of the sleeve 3.

Here, the outer circumferential surface of the sleeve 3 is the carrying surface for the developer supplied to the electrostatic latent image on the outer circumferential surface of the photosensitive drum 111. Thus, the developer on the outer circumferential surface of the sleeve 3 is used to develop the electrostatic latent image into a toner image. Therefore, if the adhesive 5 spreads onto the outer circumferential surface of the sleeve 3, it causes image defects. To prevent such inconvenience, an adhesive removal process is required to remove the adhesive 5 off the outer circumferential surface of the sleeve 3. However, even if an adhesive removal process is added, it may not be possible to fully remove the adhesive 5 off the outer circumferential surface of the sleeve 3. Also, adding an adhesive removal process leads to increased cost.

Not using the adhesive 5 would prevent any inconvenience due to its leakage but would lead to insufficient fixing strength between the sleeve 3 and flange 4.

On the other hand, in this embodiment, even if the adhesive 5 flows axially outward, it can be collected in the second groove portion 432. This allows the sleeve 3 and the flange 4 to be firmly secured while preventing the adhesive 5 from spreading onto the outer circumferential surface of the sleeve 3.

In addition, in this embodiment, not the entire groove portion 43 but only the second groove portion 432 is made deep to ensure satisfactory adhesion strength with the adhesive 5 between the sleeve 3 and the first groove portion 431.

In this embodiment, since anaerobic adhesive is used as the adhesive 5, the height H2 from the bottom surface of the second groove portion 432 to the outer circumferential surface of the first fitting portion 41 is set to 0.20 mm or more but 0.50 mm or less. This results in a small gap between the sleeve 3 and the groove portion 43 in the radial direction, reliably blocking air. Thus, the adhesive 5 can be cured reliably.

### Confirmation Experiments

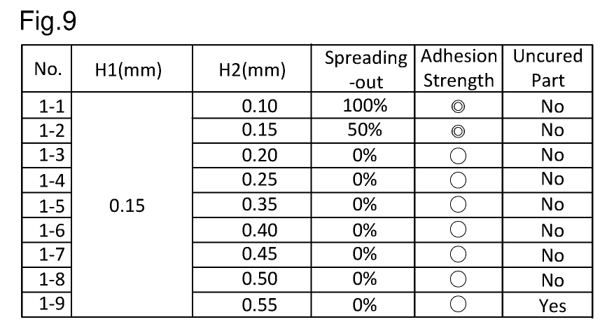

Experiments 1 to 6 were conducted to confirm the above effects. The results are shown in FIGS. 9 to 14. In confirmation experiments 1 to 6, the adhesive 5 was applied to the first groove portion 431 in the flange 4, and the process of fitting the fitting portion 40 of the flange 4 inside the sleeve 3 (hereinafter referred to simply as the fitting process) was performed. The spread of the adhesive 5 onto the outer circumferential surface of the sleeve 3 was then checked. Also the adhesion strength of the adhesive 5 between the sleeve 3 and the flange 4 was checked.

In confirmation experiments 1 to 6, the sleeve 3 and flange 4 were each made of aluminum. The inner diameter of the part of the sleeve 3 in which the flange 4 is fitted was 18.4 mm. The outer diameter of the first and second fitting portions 41 and 42 of the fitting portion 40 of the flange 4 (i.e., the maximum diameter of the fitting portion 40) was 19.0 mm. The adhesive 5 was anaerobic adhesive (LOCTITE 648, Henkel Japan Co).

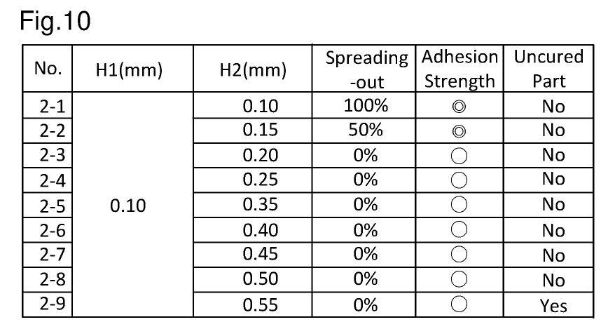

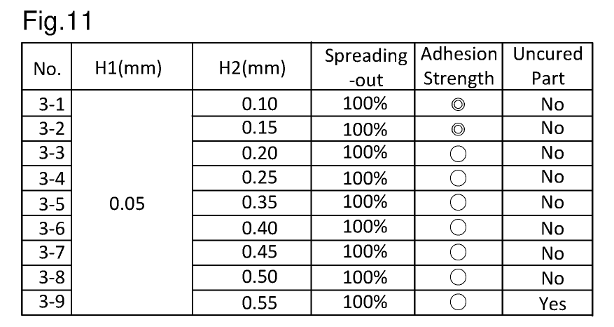

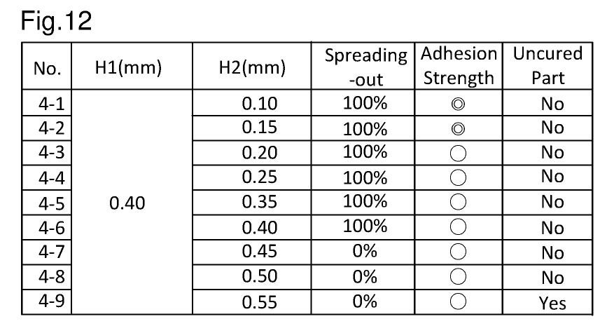

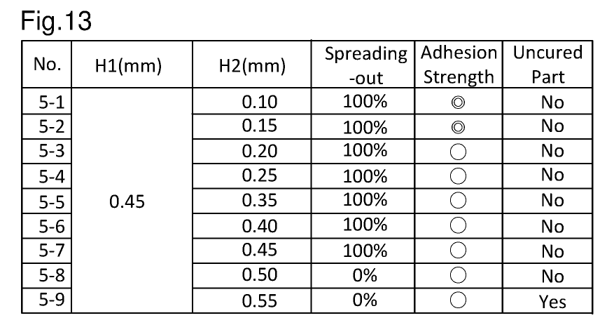

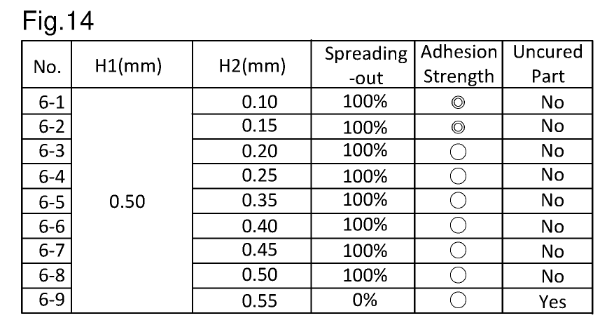

In confirmation experiment 1 (1-1 to 1-9), as shown in FIG. 9, the radial height H1 from the bottom surface of the first groove portion 431 to the outer circumferential surface of the first fitting portion 41 was 0.15 mm. In confirmation experiment 2 (2-1 to 2-9), as shown in FIG. 10, the height H1 was 0.10 mm. In confirmation experiment 3 (3-1 to 3-9), as shown in FIG. 11, the height H1 was 0.05 mm. In confirmation experiment 4 (4-1 to 4-9), as shown in FIG. 12 the height H1 was 0.40 mm. In confirmation experiment 5 (5-1 to 5-9), as shown in FIG. 13, the height H1 was 0.45 mm. In confirmation experiment 6 (6-1 to 6-9), as shown in FIG. 14, the height H1 was 0.50 mm.

In confirmation experiments 1-6, the radial height H2 from the bottom surface of the second groove portion 432 to the outer circumferential surface of the first fitting portion 41 was varied in the range from 0.10 mm to 0.55 mm.

In the experiments to check the spreading-out of the adhesive 5, the amount of adhesive 5 applied to the first groove portion 431 was an amount by volume that was 100% of the volume of the space defined by the inner surface of the first groove portion 431 and the inner circumferential surface of the sleeve 3. In the experiments to check the adhesion strength of the adhesive 5, the amount of adhesive 5 applied to the first groove portion 431 was an amount by volume that was 40% of the volume of the space defined by the inner surface of the first groove portion 431 and the inner circumferential surface of the sleeve 3.

In the experiments to check the spreading-out of the adhesive 5, the process of fitting the flange 4 in the sleeve 3 was performed 10 times in each of experiments 1-1 to 6-9. That is, in each of experiments 1-1 to 6-9, the number of samples was 10. An end part of the sleeve 3 was then irradiated with black light to check whether the adhesive 5 spread out. Here, for each of experiments 1-1 to 6-9, the ratio of the number of samples in which the adhesive 5 spread out to the total number of samples (10) was determined. The results are shown in the “Spreading-out” column in FIGS. 9 to 14. A 100% of “spreading-out” means that the adhesive 5 spread out in all 10 samples. A 50% of “spreading-out” means that the adhesive 5 spread out in five of the 10 samples.

In the experiments to check the adhesion strength of the adhesive 5, after the process of fitting the flange 4 in the sleeve 3, the torque between the sleeve 3 and the flange 4 was measured using an opening torque tester. The results are shown in the “Adhesion Strength” column in FIGS. 9 to 14. A measured torque less than 1.96 N∙m indicates weak adhesive strength. A measured torque of 1.96 N∙m or more indicates strong adhesive strength, and is indicated by a circle. A measured torque of 10 N∙m or more is indicated by a double circle. An adhesive strength of 1.96 N∙m or more is preferred.

After the process of fitting the flange 4 in the sleeve 3, whether there was an uncured part of the adhesive 5 was checked. If there is an uncured part of the adhesive 5, it may spread out, so it is preferable that there be no uncured part of the adhesive 5.

Confirmation experiment 1 (1-1 to 1-9) revealed the following. When the radial height H1 from the bottom surface of the first groove 431 to the outer circumferential surface of the first fitting portion 41 was 0.15 mm and the radial height H2 from the bottom surface of the second groove 432 to the outer circumferential surface of the first fitting portion 41 was greater than the height H1, specifically 0.20 mm or more but 0.55 mm or less, the adhesive 5 did not spread out. On the other hand, when the height H1 was 0.15 mm and the height H2 was 0.15 mm or less, the adhesive 5 spread out. However, when the height H2 was 0.15 mm (50%), less of the adhesive 5 spread out than when the height H2 was 0.10 mm (100%).

Confirmation experiment 2 (2-1 to 2-9) revealed the following. When the radial height H1 from the bottom surface of the first groove 431 to the outer circumferential surface of the first fitting portion 41 was 0.10 mm and the radial height H2 from the bottom surface of the second groove 432 to the outer circumferential surface of the first fitting portion 41 was greater than the height H1, specifically 0.20 mm or more but 0.55 mm or less, the adhesive 5 did not spread out. On the other hand, when the height H1 was 0.10 mm and the height H2 was 0.15 mm or less, the adhesive 5 spread out. However, when the height H2 was 0.15 mm (50%), less of the adhesive 5 spread out than when the height H2 was 0.10 mm (100%).

Confirmation experiment 3 (3-1 to 3-9) revealed the following. When the radial height H1 from the bottom surface of the first groove 431 to the outer circumferential surface of the first fitting portion 41 was 0.05 mm, regardless of the radial height H2 from the bottom surface of the second groove 432 to the outer circumferential surface of the first fitting portion 41, the adhesive 5 spread out.

Confirmation experiment 4 (4-1 to 4-9) revealed the following. When the radial height H1 from the bottom surface of the first groove portion 431 to the outer circumferential surface of the first fitting portion 41 was 0.40 mm and the radial height H2 from the bottom surface of the second groove portion 432 to the outer circumferential surface of the first fitting portion 41 was greater than the height H1, specifically 0.45 mm or more but 0.55 mm or less, the adhesive 5 did not spread out. On the other hand, when the height H1 was 0.40 mm and the height H2 was 0.40 mm or less, the adhesive 5 spread out.

Confirmation experiment 5 (5-1 to 5-9) revealed the following. When the radial height H1 from the bottom surface of the first groove portion 431 to the outer circumferential surface of the first fitting portion 41 was 0.45 mm and the radial height H2 from the bottom surface of the second groove 432 to the outer circumferential surface of the first fitting portion 41 was greater than the height H1, specifically 0.50 mm or more but 0.55 mm or less, the adhesive 5 did not spread out. On the other hand, when the height H1 was 0.45 mm and the height H2 was 0.45 mm or less the adhesive 5 spread out.

Confirmation experiment 6 (6-1 to 6-9) revealed the following. When the radial height H1 from the bottom surface of the first groove portion 431 to the outer circumferential surface of the first fitting portion 41 was 0.50 mm and the radial height H2 from the bottom surface of the second groove portion 432 to the outer circumferential surface of the first fitting portion 41 was greater than the height H1, specifically 0.55 mm, the adhesive 5 did not spread out. On the other hand, when the height H1 was 0.50 mm and the height H2 was 0.50 mm or less, the adhesive 5 spread out.

Based on these results, it can be said that by setting the height H1 to 0.10 mm or more but 0.50 mm or less and setting the height H2 higher than the height H1 within the range of 0.20 mm or more but 0.55 mm or less, it is possible to suppress the spreading-out of the adhesive 5.

Confirmation experiments 1-6 also revealed the following. When the height H1 was 0.10 mm or more but 0.50 mm or less and the height H2 was higher than the height H1 within the range of 0.20 mm or more but 0.55 mm or more, the adhesive 5 had satisfactory adhesion strength. Note here that, as compared with when the height H2 was 0.15 mm or less, the adhesive 5 had slightly weaker adhesion strength. However, considering that if the height H2 was 0.15 mm or less the adhesive 5 spread out, the height H2 is preferably set to 0.20 mm or more.

When the height H2 was 0.55 mm, part of the adhesive 5 remained uncured regardless of the height H1. Thus, it can be said that when anaerobic adhesive is used as adhesive 5, it is preferable to set the height H2 to 0.20 mm or more but 0.50 mm or less.

The embodiments disclosed herein should be considered to be in all respects illustrative and not restrictive. The scope of the present disclosure is defined by the appended claims, not by the description of the above embodiments, and encompasses all modifications within a scope equivalent in significance to the claims.

What is claimed is:

1. A developer carrying member comprising:
a shaft extending in a predetermined direction;
a magnet fixed to an outer circumferential surface of the shaft ;
a sleeve in a cylindrical shape with the shaft as a central axis thereof, the sleeve carrying developer on an outer circumferential surface thereof;
a flange fixed to an end opening of the sleeve in the predetermined direction and rotatably supported on the shaft, the flange rotating together with the sleeve about the central axis; and
an adhesive that bonds together the sleeve and the flange,
wherein
the flange has a fitting portion in a cylindrical shape that is fitted inside the sleeve through the end opening,
the fitting portion has:
a first fitting portion that contacts an inner circumferential surface of the sleeve;
a second fitting portion that has a same outer diameter as the first fitting portion and that contacts the inner circumferential surface of the sleeve at a position closer to the end opening than the first fitting portion; and
a groove portion that is formed between the first fitting portion and the second fitting portion in the predetermined direction and that is recessed in a radial direction with respect to outer circumferential surfaces of the first fitting portion and the second fitting portion,
the adhesive is disposed in the groove portion,
the groove portion has a first groove portion and a second groove portion,
the first groove portion and the second groove portion are formed continuously in this order in the predetermined direction from a first fitting portion side to a second fitting portion side, and
a height from a bottom surface of the second groove portion to an outer circumferential surface of the first fitting portion is greater than a height from a bottom surface of the first groove portion to the outer circumferential surface of the first fitting portion.

2. The developer carrying member according to claim 1, wherein
the height from the bottom surface of the first groove portion to the outer circumferential surface of the first fitting portion is 0.10 mm or more but 0.50 mm or less, and the height from the bottom surface of the second groove portion to the outer circumferential surface of the first fitting portion is 0.20 mm or more but 0.55 mm or less, being greater than the height from the bottom surface of the first groove portion to the outer circumferential surface of the first fitting portion.

3. The developer carrying member according to claim 2, wherein
if the adhesive is anaerobic adhesive, the height from the bottom surface of the second groove portion to the outer circumferential surface of the first fitting portion is set to 0.20 mm or more but 0.50 mm or less.

4. A method of manufacturing the developer carrying member according to claim 1, comprising:
a process of applying the adhesive to the first groove portion; and
a process of, with the adhesive applied to the first groove portion, press-fitting the fitting portion inside the sleeve through the end opening.

5. The method according to claim 4, wherein
an amount of the adhesive applied to the first groove portion is set to an amount by volume that is 40% or more but 100% or less of a volume of a space defined by an inner surface of the first groove portion and the inner circumferential surface of the sleeve.
